(19) United States
(12) Patent Application Publication
(10) Pub. No.: US 2023/0338237 A1
(43) Pub. Date: Oct. 26, 2023

(54) Vial Adapter Device

(71) Applicant: Becton, Dickinson and Company, Franklin Lakes, NJ (US)

(72) Inventors: Bo Yan, Shanghai (CN); Longxiang Huang, Suzhou (CN)

(73) Assignee: Becton, Dickinson and Company, Franklin Lakes, NJ (US)

(21) Appl. No.: 17/791,321

(22) PCT Filed: Jan. 18, 2021
(86) PCT No.: PCT/US2021/013801

§ 371 Date: Jul. 7, 2022

(30) Foreign Application Priority Data
Jan. 21, 2020 (CN) 202010068089.0

(51) Int. Cl. A61J 1/20

(52) U.S. Cl. CPC A61J 1/2096; A61J 1/2006; A61J 1/2055

(57) ABSTRACT

A vial adapter configured to allow direct fluid withdrawal with a syringe from a fluid container having a self-healing sealing member is described. The syringe is connected to the vial adapter by a vial adapter connecting member and a corresponding syringe connecting member. In use, the fluid container is pressed against the vial adapter, and the vial adapter removably locks the fluid container to the vial adapter. When removably locked, a stake of the vial adapter pierces the sealing member.

### TECHNICAL FIELD

The present disclosure generally relates to a vial adapter device for transferring a fluid to and/or from a fluid container having a sealing member, and more particularly, the disclosure relates to a vial adapter for directly withdrawing a fluid from the fluid container with a syringe, while minimizing needle tip damage and buckling.

### BACKGROUND

Medical drugs and solvents are often supplied in glass or plastic containers, such as vials, bottles or bags, which are sealed by a rubber, plastic or elastomeric bung, stopper, membrane or puncturable cap. Such sealing members prevent deterioration or contamination of the drug, allow the contents of a container to be mixed by shaking, and prevent the contents of the container from leaking out and contaminating the surroundings. A conventional hollow needle comprising a flow channel and an opening that communicates with the flow channel is usually inserted through such a sealing member to supply fluids to the container and to withdraw fluid therefrom.

To avoid needle tip damage and buckling, larger gauge needles are often utilized to pierce the sealing member, as larger gauge needles have greater structural strength than smaller gauge needles. However, larger gauge needles causes a greater puncture hole in the epidermis of a patient, and thus practitioners may balance the risk of structural deformation of the needle with invasiveness to the patient when selecting needle gauges for the given medical application. While separate needles may be used, this effectively doubles the biological waste of a given application, and increases the risk of infection by exposing the tip of a medical syringe to non-filtered air. Non-filtered air may contain undesirable particles such as dust, pollen or airborne bacteria and microbes.

Furthermore, when a container comprising medical fluid is nearly empty, the needle may not fully capture and withdraw the last few drops of the medical fluid (which may be very expensive and/or toxic) from the container. To capture the remainder of the medical fluid, the cannula is slowly and carefully retracted through the sealing member while withdrawing the medical fluid remaining in the container. However, a drug which may be toxic, may leak out and contaminate the surroundings during such a procedure, and non-filtered air may be drawn into the cannula and thus contaminate the medical fluid therein.

Thus, a need exists to reduce the likelihood of structural damage to the needle while limiting exposure to non-sterile environments and unfiltered air.

### SUMMARY

A first aspect of the present disclosure relates to a vial adapter configured to withdraw a fluid from a fluid container with a syringe. The vial adapter includes a wall having a plurality of prongs extending distally from the wall, a stake projecting distally from the wall, a lumen extending from at least one inlet through the wall, the inlet extending at least partially along the length of the stake, and an elongated body extending proximally from the wall, the body defining a longitudinal cavity.

At least one of the plurality of prongs has a protruding inner flange configured to lock to a neck of a fluid container. The lumen defines an opening in the wall, in which the lumen is in fluid communication with the at least one inlet, the lumen housing a needle cannula of the syringe, the needle cannula also being in fluid communication with the at least one inlet. The cavity of the elongated body is defined by an inner wall and a proximal opening, and the elongated body includes a connecting member configured to connect to a syringe connecting member.

In one or more embodiments, the cavity of the elongated body further defines an inner tapered surface, and the inner tapered surface creates an interference fit with a hub on the syringe.

In one or more embodiments, the lumen and the cavity defines an inner channel through which the cannula of the syringe passes through, the cannula being non-removably press-fit into a hub of the syringe. In one or more embodiments, the cannula does not extend beyond the at least one inlet of the stake.

In one or more embodiments, the at least one inlet of the stake does not extend beyond a sealing member of the fluid container when the fluid container is fully depressed against the wall and the stake punctures the sealing member when the sealing member is fully depressed against the wall, causing fluid communication from the fluid container through the at least one inlet and lumen.

In one or more embodiments, the at least one inlet of the stake extends beyond the sealing member of the container when the fluid container is fully depressed against the wall.

In one or more embodiments, the inlet exposes an air ventilation channel for normalizing internal pressure of the vial.

In one or more embodiments, the prongs elastically deform when the sealing member of the fluid container is pressed against the stake, the prongs removably locking the fluid container when the fluid container is fully depressed against the wall.

In one or more embodiments, the prongs elastically deform when the sealing member of the fluid container is pressed against the stake, the prongs permanently locking the fluid container when the fluid container is fully depressed against the wall.

In one or more embodiments, the vial adapter further comprises a removable seal disposed over the prongs.

In one or more embodiments, the connecting member of the elongated body comprises a male thread and the syringe connecting member comprises a female thread. In one or more embodiments, the connecting member of the elongated body and the syringe connecting member comprise luer fittings. In one or more embodiments, the connecting member of the elongated body comprises a flange and the syringe connecting member comprises a twist-locking receptacle.

A second aspect of the present disclosure relates to a fluid extraction kit comprising a vial adapter, a fluid container and a syringe configured to withdraw a fluid from the fluid container with the syringe. The fluid container has a neck and a sealing member abutting the neck. The syringe comprises a plunger rod and a barrel, the barrel defining an open proximal end through which the plunger rod is disposed and a distal end, the distal end defining a distal wall, the distal wall having a collar and an integrally formed needle hub through which a needle cannula is disposed within a lumen of the needle hub, the needle cannula and needle hub being in fluid communication with the barrel, the collar having a corresponding connection member.

The vial adapter comprises a wall having a plurality of prongs extending distally from the wall, at least one of the plurality of prongs having a protruding inner flange configured to lock to the neck of the fluid container. The vial adapter also comprises a stake having a tip projecting distally from the wall defining a length, the stake having at least one inlet extending at least partially along the length of the stake. The vial adapter further comprises a lumen extending from the at least one inlet through the wall, the lumen defining an opening in the wall, the lumen being in fluid communication with the at least one inlet and an elongated body extending proximally from the wall defining a longitudinal cavity, the cavity defining an inner wall and a proximal opening, the elongated body having a connecting member disposed longitudinally along an outer wall of the elongated body, the connecting member configured to removably secure the vial adapter to a syringe connecting member.

In one or more embodiments, the cavity further defines an inner tapered surface, the inner tapered surface creating an interference fit with a needle hub on the syringe.

In one or more embodiments, the lumen and the cavity define an inner channel through which the needle cannula of the syringe passes through, the needle cannula being non-removably press-fit into the hub of the syringe, the cannula not extending beyond the at least one inlet of the stake.

In one or more embodiments, the at least one inlet of the stake does not extend beyond the sealing member when the fluid container is fully depressed against the wall and wherein the stake punctures the sealing member when the sealing member is fully depressed against the wall, providing fluid communication from the fluid container through the at least one inlet and lumen.

In one or more embodiments, the prongs elastically deform when the sealing member of the fluid container is pressed against the stake, the prongs removably locking the fluid container when the fluid container is fully depressed against the wall.

In one or more embodiments, the prongs elastically deform when the sealing member of the fluid container is pressed against the stake, the prongs permanently locking the fluid container when the fluid container is fully depressed against the wall.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the disclosure will be set forth in the description which follows, and in part will be obvious from the description, or may be learned by the practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth hereinafter.

### BRIEF DESCRIPTION OF THE DRAWINGS

FIG. 1A illustrates a perspective view of a vial adapter attached to a syringe and vial in accordance with a first embodiment of the present disclosure;

FIG. 1B illustrates an exploded view of the vial adapter, syringe and vial in accordance with the first embodiment of the present disclosure;

FIG. 2A illustrates a perspective view of the vial adapter device in accordance with the first embodiment of the present disclosure;

FIG. 2B illustrates a cross sectional view of the vial adapter device in accordance with the first embodiment of the present disclosure;

FIG. 3 illustrates a cross sectional view of the syringe in accordance with the first embodiment of the present disclosure;

FIG. 4 illustrates a cross sectional view of the vial adapter attached to the syringe in accordance with the first embodiment of the present disclosure;

FIG. 5 illustrates an exploded side view of the vial as part of a vial adapter kit in accordance with the first embodiment of the present disclosure;

FIG. 6 illustrates a cross sectional view of the vial adapter device attached to a vial in accordance with the first embodiment of the present disclosure;

FIG. 7 illustrates a cross-sectional view of the vial adapter device taken along line 7-7 of FIG. 2A; and,

FIG. 8 illustrates a side perspective view of the vial adapter device in accordance with the first embodiment of the present disclosure.

### DETAILED DESCRIPTION

Before describing several exemplary embodiments of the disclosure, it is to be understood that the disclosure is not limited to the details of construction or process steps set forth in the following description. The disclosure is capable of other embodiments and of being practiced or being carried out in various ways.

For purposes of the description hereinafter, the terms “upper”, “lower”, “right”, “left”, “vertical”, “horizontal”, “top”, “bottom”, “lateral”, “longitudinal”, and derivatives thereof shall relate to the disclosure as it is oriented in the drawing figures. However, it is to be understood that the disclosure may assume alternative variations and step sequences, except where expressly specified to the contrary. It is also to be understood that the specific devices and processes illustrated in the attached drawings, and described in the following specification, are simply exemplary embodiments of the disclosure. Hence, specific dimensions and other physical characteristics related to the embodiments disclosed herein are not to be considered as limiting.

Reference to “needle” includes needles that are configured to fill and/or inject liquids into or out of a syringe. In this disclosure, a convention is followed wherein the portion of a needle closest to the practitioner operating the needle is termed “proximal” and the portion of the needle toward the patient (for injection) or vial containing liquid (for filling) and farthest from the practitioner is termed “distal.”

As used herein, a “fill needle” refers to a needle that is configured to fill a syringe, but in some embodiments, is not configured to inject a patient. For example, in some embodiments, a fill needle is a blunt needle that is not configured or adapted to penetrate a patient’s skin, but is configured or adapted to penetrate a rubber stopper of a fluid container.

As used herein, the term “syringe” refers to a simple pump-like device consisting of a plunger rod that fits tightly in a barrel or tube. The plunger rod is pulled or pushed along inside the barrel, allowing the syringe to take in and expel a liquid or gas through an opening at the open end of the barrel.

As used herein, “fluid container” refers to a vial having a sealing member that is configured to hermetically seal the contents of the fluid container, preferably a liquid. The fluid container in some embodiments comprises a substantially cylindrical container body with a neck disposed opposite a closed end. The neck defines an opening which is covered by a hermetically sealed sealing member, commonly referred to as an elastomeric or rubber “stopper” or “septum”. The sealing member in one or more embodiments is hot or cold fused directly to the neck. In other embodiments, an end cap compresses the sealing member to the neck, the end cap being hermetically affixed to the neck. The end cap of some embodiments is secured with an adhesive, a threaded connection or a locking connection to the neck. The fluid container according to one or more embodiments comprises glass, ceramic, metal, a polymer or plastic. Where non-collapsible wall materials are used (such as glass, ceramic, metals and hard plastics), ventilation features are often integral to the fluid container, integral to the sealing member, or a feature of the fill needle. Where collapsible wall materials are used (such as soft polymers), extraction may be performed without ventilation features as the walls collapse due to the pressure differential between the container interior and the outside atmosphere when the contents are extracted, creating a vacuum in the container. Alternatively, a practitioner may first prime the container by injecting air into the container with the fill needle and subsequently withdrawing the contents of the fluid container, stabilizing the pressure. In some embodiments where priming is required, the syringe is commercially provided with pre-filled sterilized gas to be transferred to the fluid container before withdrawing fluid. When contents are substantially withdrawn and the fill needle is unable to further capture the remainder, the fluid container is inverted or placed in an upward position and the fill needle slightly withdrawn to capture the accumulated remainder within the neck.

Exemplary embodiments for couplers, fittings, ports and adapters include commercially available luer locks, luer slip ports, locking ports, threaded connections, interlocking connection or generally other common medical device fitting known in the art.

The present disclosure relates to a vial adapter configured to withdraw medical fluid from a fluid container having a septum without the need to change needles after vial filling to an administration needle configured to inject a patient. The vial adapter of one or more embodiments enables practitioners to use small gauge needles while withdrawing medical fluid from a fluid container while also minimizing needle tip damage and buckling to the small gauge needle. By way of example, but not limitation, the vial adapter allows for a single hypodermic needle, as small as 27 gauge to be utilized to withdraw and administer or inject medical fluid without damaging the needle or the need to use a second needle such as a fill needle.

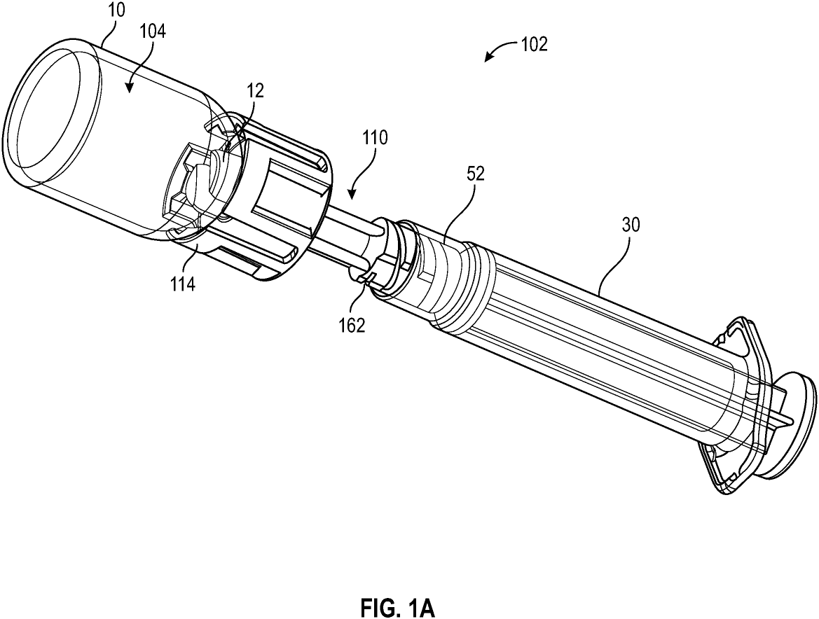

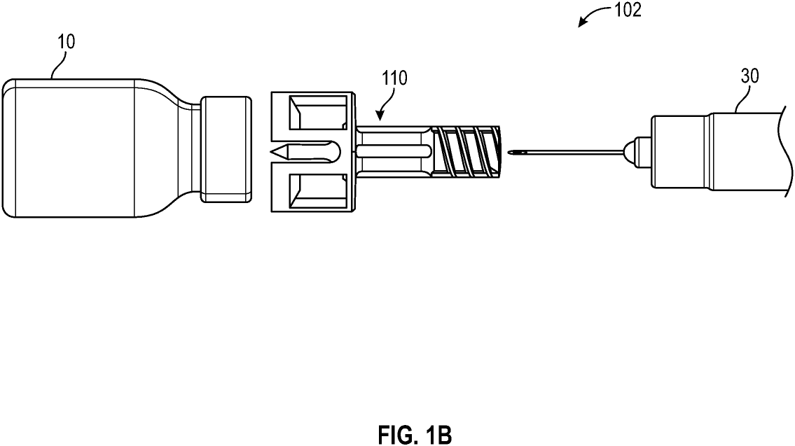

As depicted in FIGS. 1A and 1B, the present disclosure relates to a vial adapter 110 and an exemplary fluid extraction kit 102 configured to directly withdraw a fluid 104 from a fluid container 10 having a self-healing sealing member 12, with a syringe 30. In one or more embodiments, the syringe 30 is first connected to the vial adapter 110. The fluid container 10 is then pressed against the vial adapter 110, and the vial adapter 110 removably locks the fluid container 10 to the vial adapter. While removably locked, a practitioner may withdraw fluid 104 by moving a plunger rod 32 in a proximal direction.

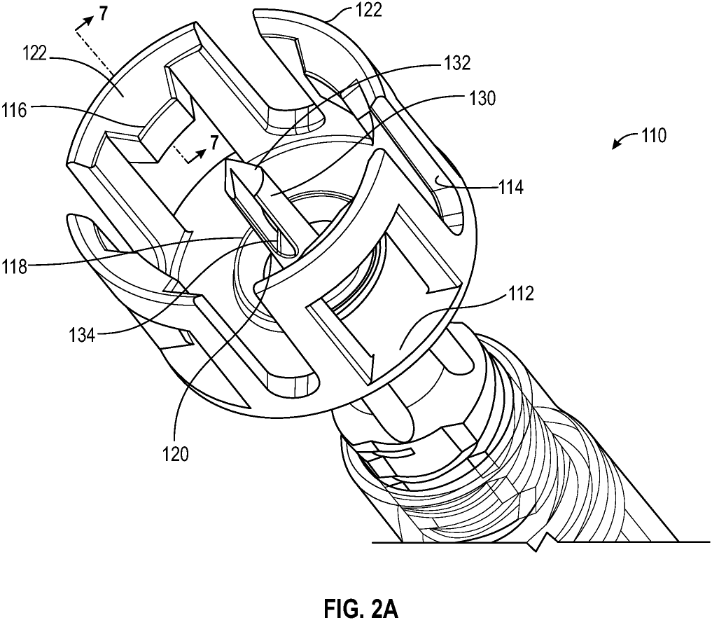

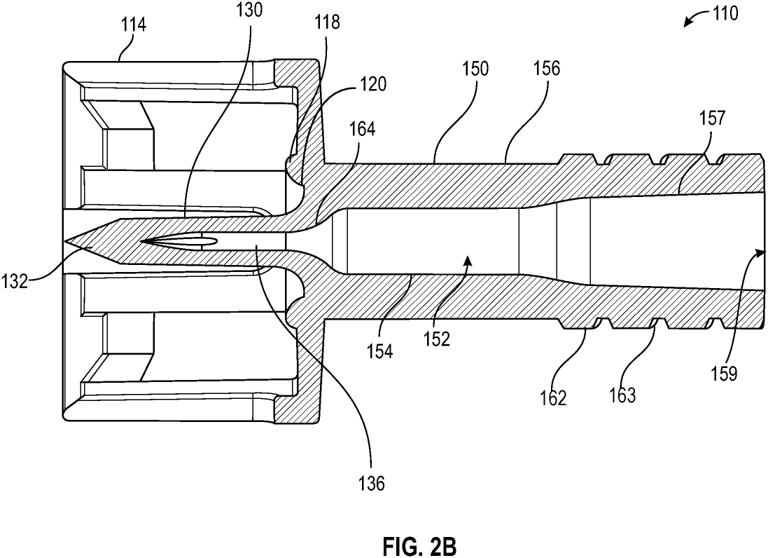

As depicted in FIGS. 2A and 2B, the vial adapter 110 comprises a substantially elongated body 150 having a distal wall 112. In the embodiment shown, the distal wall 112 has a substantially circular profile. A stake 130 projects in a distal direction from the distal wall 112 of the vial adapter 110. The stake 130 is disposed at the center of the distal wall 112 to allow for direct piercing of the sealing member 12 (not shown). To aid in piercing of the sealing member 12, the stake 130 has a sharp tip, which is shown as having a beveled tip 132. The stake 130 further comprises at least one elongated inlet 134 extending from the beveled tip 132 at least partially along the length of the stake 130. The at least one elongated inlet 134 is in fluid communication with a lumen 136 of the vial adapter 110. The lumen 136 extends from the at least one inlet 134 through the distal wall 112. The elongated inlet 134 may be of any shape, such as rectangular, square, circular or oval, which communicates with the lumen 136. The at least one elongated inlet 134 extends longitudinally along about 50% of the length of the stake 130, either from the beveled tip 132 or a few millimeters from the beveled tip 132, to ensure that at least part of the at least one elongated inlet 134 opening is in fluid communication with the fluid 104 of the fluid container 10 when the fluid container 10 is pressed against the vial adapter 110.

The vial adapter 110 further comprises a plurality of prongs 114 disposed around the perimeter of the distal wall 112. The plurality of prongs 114 extend in a distal direction from the distal wall 112, and at least one of the plurality of prongs have a protruding inner flange 116. In some embodiments, each of the plurality of prongs has a protruding inner flange 116 defining a plurality of inner flanges 116 for removably securing the fluid container 10 to the vial adapter 110.

The distal wall 112 in some embodiments further includes a distally facing circular protrusion 118 and a circular trench 120, the circular trench 120 being disposed within the circular protrusion 118. The circular protrusion 118 and the circular trench 120 are disposed concentrically to the distal wall 112. In one or more embodiments, the fluid container 10 abuts the circular protrusion 118 when the fluid container 10 is fully depressed against the distal wall 112. When fluid 104 is being withdrawn, leakage may accumulate in the circular trench 120, preventing further spillage outside of the vial adapter 110. In one or more embodiments, the at least one elongated inlet 134 does not extend to the height of the circular protrusion 118, preventing the at least one elongated inlet 134 from exposure to the outside environment when the sealing member 12 is fully depressed against the distal wall 112.

The elongated body 150 further defines a longitudinal cavity 152 in fluid communication with the lumen 136. The cavity 152 is further defined by an inner sidewall 154, an outer sidewall 156, and a proximal opening 159. The inner sidewall 154 further includes a proximal portion 157 and a distal internal bevel 164. A connecting element 162 is longitudinally disposed along a proximal portion of the outer sidewall 156. In a specific embodiment, the connecting element 162 includes a plurality of female threads 163 which have a helical shape. The connecting element 162 removably secures the vial adapter 110 to a corresponding connecting element 52 of the syringe 30. In some embodiments the device includes at least one male thread having a helical shape. In even further embodiments, the connecting element 162 includes a flange for twist-locking into a corresponding receptacle.

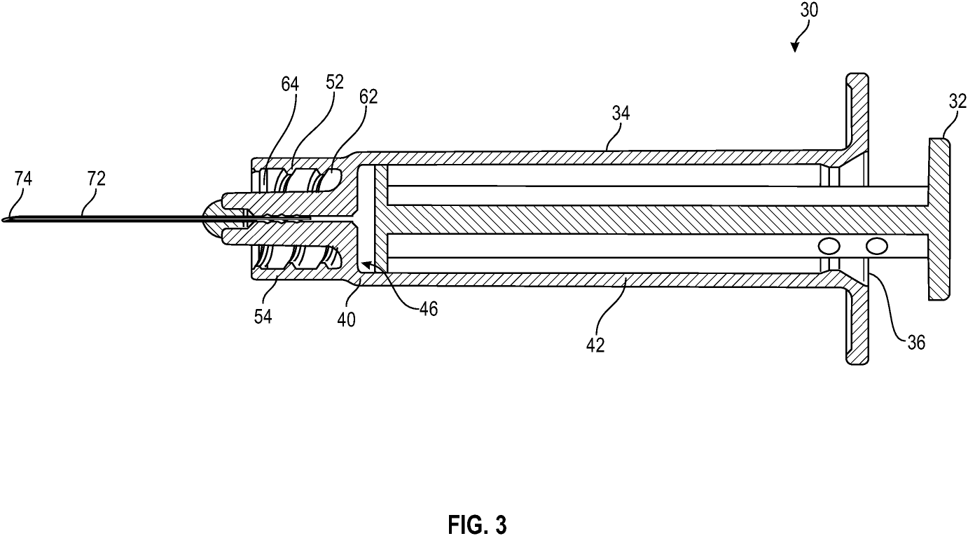

As depicted in FIG. 3 the syringe 30 comprises a barrel 34 and a plunger rod 32. The barrel 34 defines an open proximal end 36, a distal end 38 and a distal wall 40. A sidewall 42 extends from the distal end 38 to the open proximal end 36 and includes an interior surface that defines a chamber 46 for retaining or holding fluids, which in some embodiments includes liquid medication and/or other liquids. The collar 54 of the syringe 30 is disposed on the distal end 38 of the barrel 34 and extends from the distal wall 40 of the barrel 34 to form a compartment 62 that surrounds a conical needle hub 64, the needle hub 64 being integrally formed to the distal wall 40. In one or more embodiments, the needle cannula 72 is non-removably press-fit into a hub of the syringe. The collar 54 includes an inner surface defining compartment 62 and an open distal end. The inner wall of the collar 54 has the corresponding connecting element 52. The collar 54 surrounds the needle hub 64, the needle hub 64 protruding beyond the collar 54. The interior surface of the syringe barrel 34 may have a smooth surface that is free of any protrusions or depressions. In use, the plunger rod 32 is inserted into the open proximal end 36 of the syringe barrel 34.

A lumen of the syringe 30 extending the length of a hollow needle cannula 72, defines an open passageway through which the needle cannula 72 is in fluid communication with a chamber of a syringe barrel of the syringe 30. In one or more embodiments, the needle cannula 72 frictionally engages the hub 64. The needle cannula 72 is disposed in the hub 64. In one or more embodiments, the needle cannula 72 has a beveled needle tip 74. The needle cannula 72 in accordance with embodiments of the present disclosure is formed from conventional materials such as steel, namely stainless steel. It will be realized by the skilled artisan that medical grade plastics, composites, ceramics, or like materials can be substituted.

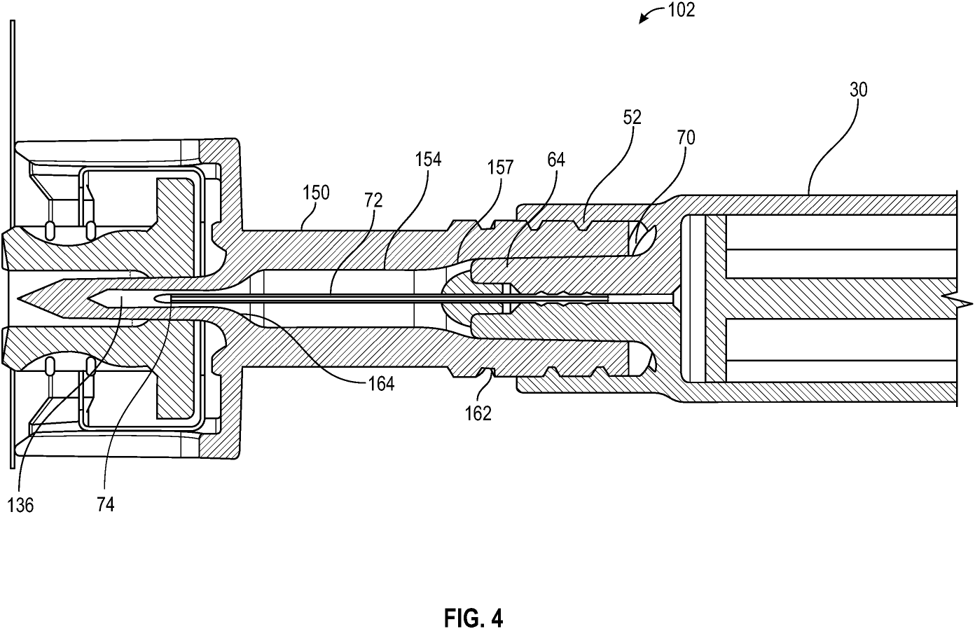

FIG. 4 illustrates syringe 30 threadably engaged with the vial adapter 110. The connecting element 162 of the vial adapter 110 is threaded into the corresponding connecting element 52 of the syringe 30. The proximal portion 157 of the inner sidewall 154 of the elongated body 150 may be conical in shape, or tapered in shape, to create an interference fit with the needle hub 64 of the syringe 30. In a specific embodiment, the interference fit between the hub 64 and the proximal portion 157 of the inner sidewall 154 creates a fluid-tight seal. In some embodiments, the interference fit may be sufficient to secure the vial adapter 110 to the syringe 30 without utilizing connecting elements (162, 52). In further embodiments, the connecting elements (162, 52) may be a Luer slip connection.

In use, as the vial adapter 110 is threaded into the collar 54 of the syringe 30, the needle cannula 72 is inserted and housed into the lumen 136 of the elongated body 150. The needle cannula 72 extends at least partially through the stake 130.Insertion of the needle cannula 72 is aided by the internal bevel 164. The lumen 136 of the elongated body 150 and the cavity 152 define an inner channel or a flow channel through which the contents of the fluid container 10 (not shown) may flow into and/or out of the fluid container 10 and the at least one elongated inlet 134. The needle cannula 72 is in fluid communication with the lumen 136 of the elongated body 150. Thus, when the stake 130 pierces the sealing member 12 of the fluid container 10, fluid 104 from the fluid container 10 may flow from the at least one elongated inlet 134 to the lumen 136 of the elongated body 150 to the needle cannula 72 and with the chamber 46 of the syringe 30. With the vial adapter 110 threaded into the collar 54 of the syringe 30, the stake 130 protects the needle cannula 72 and serves as a fill needle, and needle cannula 72 serves an administering needle to deliver medical fluid to a patient.

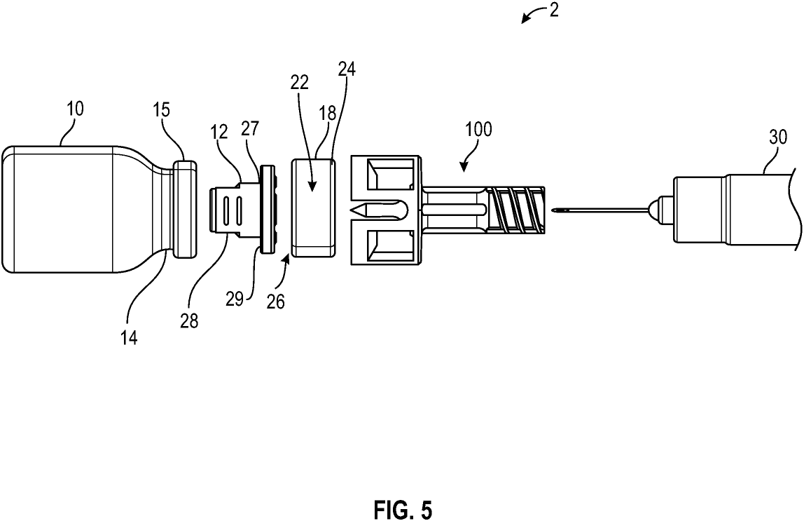

As shown in FIG. 5, the fluid container 10 of a specific embodiment comprises the end cap 18 which envelops and compresses the sealing member 12 against a spout 15. The spout 15 is disposed on neck 14 of the fluid container 10. The end cap 18 includes a generally cylindrical end cap body having an inner sidewall, an outer cap sidewall 22, a proximal cap end 24, and a substantially open distal cap end 26. The open distal cap end 26 defining an interior cavity extending to a bottom wall (not shown), the bottom wall being disposed at the proximal cap end 24. The bottom wall of the end cap 18 having a concentric aperture (not shown) extending therethrough. The sealing member in the embodiment shown comprises a generally cylindrical distal portion 28 and a generally cylindrical proximal portion 29. The distal portion 28 having a smaller diameter than the diameter of the proximal portion 29. The transition from the distal portion 28 to the proximal portion 29 defines a ridge 27. Other embodiments of the sealing member include a generally cylindrical body having a substantially trapezoidal, triangular or tapered cross-section. The material of the sealing member 12 in some embodiments is generally an elastic polymer or rubber, creating a barrier which allows for the repeated piercing of conventional needles and the transfer of fluid through the barrier without leakage. In one or more embodiments, the sealing member 12 is in the form of a septum.

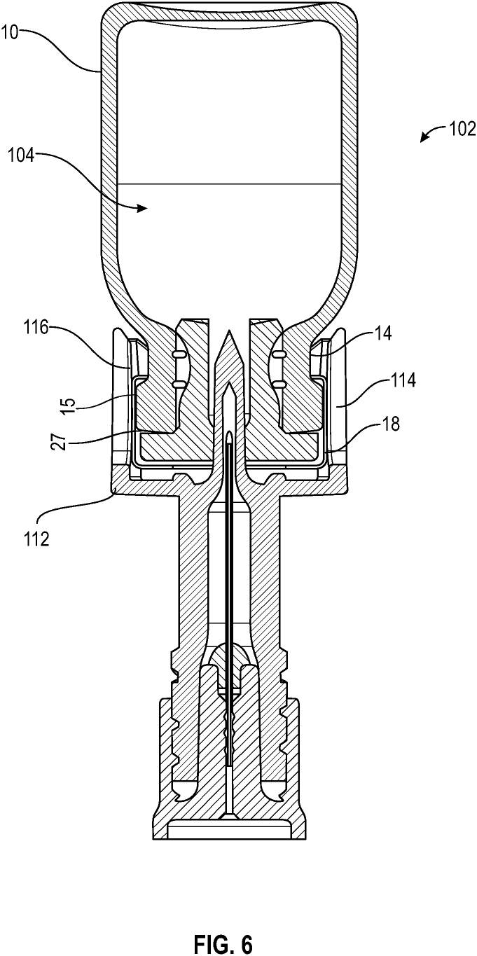

Referring to FIG. 6, in use, the fluid container 10 is pressed against the vial adapter 110, and the vial adapter 110 removably secures the fluid container 10 to the vial adapter 110 by the plurality of prongs 114 of the vial adapter 110. As the fluid container 10 is pushed against the distal wall 112, the protruding inner flanges 116 of the plurality of prongs 114 interfere with the end cap 18 of the fluid container 10. The interference between the protruding inner flanges 116 and the end cap 18 cause the plurality of prongs 114 to elastically deform, allowing the fluid container 10 to be fully depressed, abutting the distal wall 112. In a fully depressed position, the prongs 114 fully envelop the end cap 18, and at least partially envelop the neck 14 of the fluid container 10. The ridge 27 abuts the spout 15 of the fluid container 10. The spout 15 is joined with the end cap 18 by an interference press-fit. In one or more embodiments, the spout 15 is joined with the end cap 18 using a threaded connection, a locking mechanism or medical grade adhesive, or a combination thereof. Fully assembled, the aperture of the end cap 18 is sufficiently large enough to allow for a conventional needle, a fill needle or, in the present embodiment, the stake 130 to pierce through the sealing member 12. In some embodiments, the fluid container 10 has a hermetically sealed sealing member directly adhered to the spout 15, without the need for an end cap.

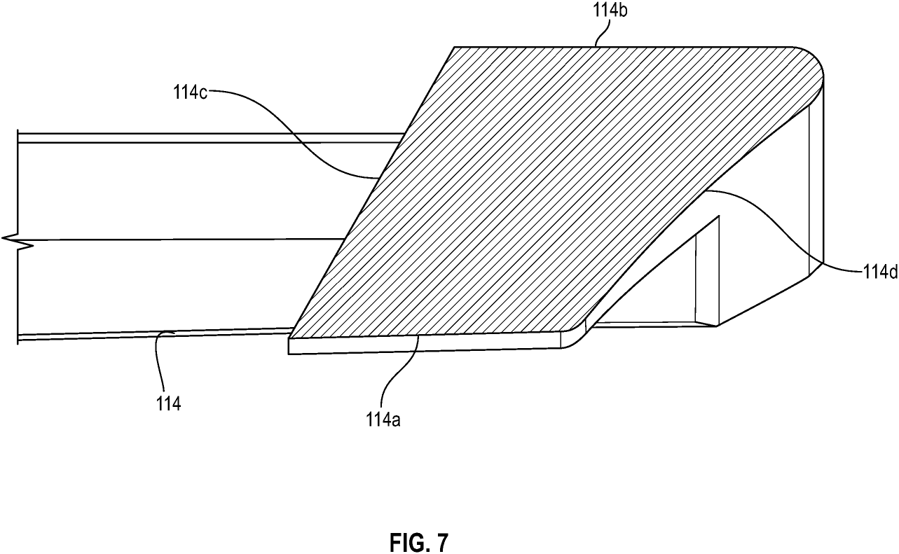

As shown in FIGS. 6 and 7, the cross-section of the plurality of protruding inner flanges 116 has a substantially rhombic cross section, defining an anterior surface 114a, a posterior surface 114b, a proximal surface 114c and a distal surface 114d. The distal surface 114d may be a concave or rounded surface, allowing for ease of insertion of the end cap 18. The anterior surface 114a removably abuts the neck 14 of the fluid container 10, wherein the length of the anterior surface 114a is less than the length of the neck 14. The proximal surface 114c and the anterior surface 114a form a beak defined by the downward position of the surfaces (114a, 114c) which captures the end cap 18 (not shown). Finally, the distal surface 114d is beveled to allow for centering of the sealing member 12 as the fluid container 10 is pushed against the vial adapter 110. In alternative embodiments, where the fluid container 10 may have a hermetically sealed sealing member directly adhered to the spout 15, without the need for an end cap, the hook may capture a spout (not shown) of the fluid container 10.

Due to the infinitely varying dimensions of commercially available fluid containers, a multitude of sizes of vial adapters may be provided having variable wall diameters or prong lengths. In one or more embodiments, the diameter of the distal wall 112 is equal to or slightly larger than the diameter of the end cap 18 as to allow the plurality of prongs 114 to restore to their natural position after elastically deforming to allow the protruding inner flanges 116 to nest into the recess formed by the neck 14. Likewise, in some embodiments, the height of the plurality of prongs 114 is at least the height of the end cap 18 allowing for the protruding inner flanges 116 securely slide into the recess formed by the neck 14.

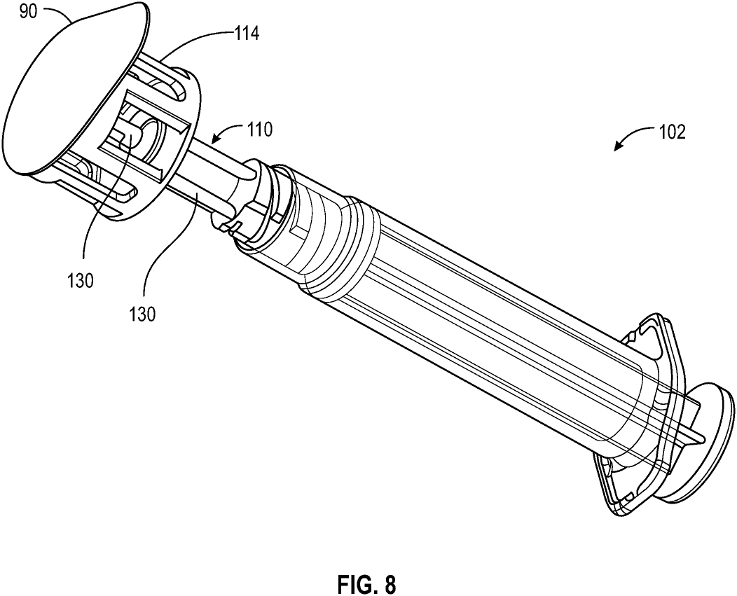

As shown in FIG. 8, a removable seal 90 is distally disposed against the plurality of prongs 114 of the vial adapter 110. The removable seal 90 defines a sealed region in which the stake 130 disposed. According to one or more embodiments, the removable seal 90 comprises a pull tab. The removable seal 90 reduces or prevents contamination of the stake 130 during shipping and storage of the safety needle device. The removable seal 90 is generally kept in the closed position until just prior to an injection and/or aspiration procedure, at which time the removable seal 90 is removed from the housing. The removable seal minimizes entry of potential particulate hazard and also provides a substantially impermeable enclosure for the stake 130 prior to use of the vial adapter 110. The removable seal provides a sufficient seal at a range of temperatures, pressures, and humidity levels. In a specific embodiment, the syringe 30 and the vial adapter 110 are pre-packaged together as a kit 102 in a sealed or sterilized package, such as blister packaging.

An aspect of the disclosure comprises a method in which a practitioner may withdraw the contents of fluid container 10 using the vial adapter and subsequent administration. A practitioner may remove the assembled kit 102 from a package such as a medical tray or thermoformed package and subsequently remove the removable seal 90. The practitioner may then depress the fluid container 10 into the vial adapter 110 by exerting a longitudinal force against the vial adapter 110. The end cap 18 and the neck 14 of the fluid container 10 interferes with the plurality of prongs 114, causing the plurality of prongs 114 to elastically deform, while the stake 130 concurrently pierces the sealing member 12 and subsequently penetrates the sealing member 12 with the application of a continuous longitudinal force against the vial adapter 110. When further depressed, the plurality of prongs 114 return to their normal position and the protruding inner flanges 116 releasably lock the neck 14 of the sealing member. Furthermore, the sealing member 12 is fully abutted against the circular protrusion 118 and the stake 130 has fully pierced the sealing member 12, allowing fluid communication between the fluid 104 in the fluid container 10 and the lumen 136 through the plurality of prongs 114.

Alternatively, the vial adapter 110 may be packaged individually and the practitioner may first secure the vial adapter 110 to the syringe 30 before withdrawing fluid 104 from the fluid container 10. In this alternative method, the connecting element 162 of the vial adapter 110 is first removably secured to the corresponding connecting element 52 of the syringe 30. By engaging the two connecting elements (162, 52), the needle cannula 72 self-centers within the lumen 136 vial adapter 110. The self-centering is further aided by the threading motion establishing the removably secured connection and by the internal bevel 164 within the cavity 152 of the elongated body 150. When fully secured, the needle tip 74 does not extend beyond the at least one inlet 134 of the stake 130. Moving the plunger rod 32 in a proximal direction away from the barrel 34 creates a negative pressure within the barrel 34. The negative pressure causes the fluid 104 to flow through the at least one inlet 134 to the needle cannula 72, into the barrel 34, allowing for fluid extraction as the negative pressure approaches zero.

In an alternative embodiment, the at least one inlet 134 extends beyond the sealing member 12 of the fluid container 10 when the fluid container 10 is fully depressed against the distal wall 112, the at least one inlet 134 exposing an air ventilation channel (not shown) for normalizing the internal pressure of the vial by which air may flow into the fluid container 10 where a negative pressure is created by pulling the plunger rod 32 in the proximal direction away from the barrel 34.

After the desired amount of fluid 104 is withdrawn into the barrel 34, the two connecting elements (162, 52) are disengaged by twisting the vial adapter 110 in the opposite direction. The practitioner may unsecure the vial adapter 110 by manipulating the fluid container 10, which is still secured to the vial adapter 110. By manipulating the fluid container 10, there is a reduced risk of injury as the needle cannula 72 is further away from the practitioner’s hands due to the added length of the vial adapter 110. The needle cannula 72 may then freely be inserted into a patient’s skin for administration. After administration, the vial adapter 110 may be secured again to the used syringe 30, allowing for the disposal of the vial adapter 110, syringe 30, and fluid container 10 in accordance with accepted hazardous waste procedures.

As shown in FIG. 8, a plurality of gripping elements 160 is longitudinally disposed along the distal portion of the outer sidewall 156. In one or embodiment, the plurality of gripping elements 158 are longitudinally disposed ribs, which aid both in removal of the vial adapter 110 from the syringe 30 and provide structural support for the elongated body 150.

In yet another embodiment, the fluid container 10 is primed by first by injecting air into the fluid container 10 creating a positive pressure within the fluid container 10 and subsequently withdrawing the fluid 104 by pulling the plunger rod 32 in the proximal direction away from the barrel 34, stabilizing the pressure of the fluid container 10 to near zero.

Reference throughout this specification to “one embodiment,” “certain embodiments,” “various embodiments,” “one or more embodiments” or “an embodiment” means that a particular feature, structure, material, or characteristic described in connection with the embodiment is included in at least one embodiment of the disclosure. Thus, the appearances of the phrases such as “in one or more embodiments,” “in certain embodiments,” “in various embodiments,” “in one embodiment” or “in an embodiment” in various places throughout this specification are not necessarily referring to the same embodiment of the disclosure. Furthermore, the particular features, structures, materials, or characteristics may be combined in any suitable manner in one or more embodiments.

Although the disclosure herein provided a description with reference to particular embodiments, it is to be understood that these embodiments are merely illustrative of the principles and applications of the disclosure. It will be apparent to those skilled in the art that various modifications and variations can be made to the present disclosure without departing from the spirit and scope thereof. Thus, it is intended that the present disclosure include modifications and variations that are within the scope of the appended claims and their equivalents.

What is claimed is:

1. A vial adapter configured to withdraw a fluid from a fluid container with a syringe, the vial adapter comprising:
a wall having a plurality of prongs extending distally from the wall, at least one of the plurality of prongs having a protruding inner flange configured to lock to a neck of a fluid container;
a stake projecting distally from the wall and defining a length, the stake having at least one inlet extending at least partially along the length of the stake;
a lumen extending from the at least one inlet through the wall, the lumen defining an opening in the wall; the lumen being in fluid communication with the at least one inlet, the lumen housing a needle cannula of the syringe, the needle cannula being in fluid communication with the at least one inlet; and,
an elongated body extending proximally from the wall defining a longitudinal cavity, the cavity defining an inner wall and a proximal opening, the elongated body including a connecting member configured to connect to a syringe connecting member.

2. The vial adapter of claim 1 wherein the cavity further defines an inner tapered surface, the inner tapered surface creates an interference fit with a needle hub on the syringe.

3. The vial adapter of claim 1, wherein the lumen and the cavity define an inner channel through which the needle cannula of the syringe passes through, the needle cannula being non-removably press-fit into a needle hub of the syringe.

4. The vial adapter of claim 3, wherein the needle cannula does not extend beyond the at least one inlet of the stake.

5. The vial adapter of claim 1, wherein the at least one inlet of the stake does not extend beyond a sealing member of the fluid container when the fluid container is fully depressed against the wall and the stake punctures the sealing member when the sealing member is fully depressed against the wall, causing fluid communication from the fluid container through the at least one inlet and lumen.

6. The vial adapter of claim 1, wherein the at least one inlet of the stake extends beyond a sealing member of the container when the fluid container is fully depressed against the wall.

7. The vial adapter of claim 1, wherein a cross-section of the plurality of protruding inner flanges has a substantially rhombic cross section.

8. The vial adapter of claim 1, wherein the prongs elastically deform when a sealing member of the fluid container is pressed against the stake, the prongs removably locking the fluid container when the fluid container is fully depressed against the wall.

9. The vial adapter of claim 1, wherein the prongs elastically deform when a sealing member of the fluid container is pressed against the stake, the prongs permanently locking the fluid container when the fluid container is fully depressed against the wall.

10. The vial adapter of claim 1, further comprising a removable seal disposed over the prongs.

11. The vial adapter of claim 1, wherein the connecting member of the elongated body comprises a male thread and the syringe connecting member comprises a female thread.

12. The vial adapter of claim 11, wherein the connecting member of the elongated body and the syringe connecting member comprise luer fittings.

13. The vial adapter of claim 1, wherein the connecting member of the elongated body comprises a flange and the syringe connecting member comprises a twist-locking receptacle.

14. A fluid extraction kit comprising a vial adapter, a fluid container and a syringe configured to withdraw a fluid from the fluid container with the syringe the fluid container having a neck and a sealing member abutting the neck;
the syringe comprising a plunger rod and a barrel, the barrel defining an open proximal end through which the plunger rod is disposed and a distal end, the distal end defining a distal wall, the distal wall having a collar and an integrally formed needle hub through which a needle cannula is disposed within a lumen of the needle hub, the needle cannula and needle hub being in fluid communication with the barrel, the collar having a corresponding connection member;
the vial adapter comprising
a wall having a plurality of prongs extending distally from the wall, at least one of the plurality of prongs having a protruding inner flange configured to lock to the neck of the fluid container;
a stake having a tip projecting distally from the wall defining a length, the stake having at least one inlet extending at least partially along the length of the stake,
a lumen extending from the at least one inlet through the wall, the lumen defining an opening in the wall, the lumen being in fluid communication with the at least one inlet; and
an elongated body extending proximally from the wall defining a longitudinal cavity, the cavity defining an inner wall and a proximal opening, the elongated body having a connecting member disposed longitudinally along an outer wall of the elongated body, the connecting member configured to removably secure the vial adapter to a syringe connecting member.

15. The fluid extraction kit of claim 14, wherein the cavity further defines an inner tapered surface, the inner tapered surface creating an interference fit with a needle hub on the syringe.

16. The fluid extraction kit of claim 14, wherein the lumen and the cavity define an inner channel through which the needle cannula of the syringe passes through, the needle cannula being non-removably press-fit into the needle hub of the syringe, the cannula not extending beyond the at least one inlet of the stake.

17. The fluid extraction kit of claim 14, wherein the at least one inlet of the stake does not extend beyond the sealing member when the fluid container is fully depressed against the wall and wherein the stake punctures the sealing member when the sealing member is fully depressed against the wall, providing fluid communication from the fluid container through the at least one inlet and lumen.

18. The fluid extraction kit of claim 14, wherein the prongs elastically deform when the sealing member of the fluid container is pressed against the stake, the prongs removably locking the fluid container when the fluid container is fully depressed against the wall.

19. The fluid extraction kit of claim 14, wherein the prongs elastically deform when the sealing member of the fluid container is pressed against the stake, the prongs permanently locking the fluid container when the fluid container is fully depressed against the wall.

20. The fluid extraction kit of claim 14, wherein the connecting member of the elongated body comprises a male thread and syringe connecting member comprises a female thread.
